(19) United States
(12) Patent Application Publication
(10) Pub. No.: US 2025/0284423 A1
(43) Pub. Date: Sep. 11, 2025

(54) DATA PROCESSING METHOD AND APPARATUS

(71) Applicant: CLOUD INTELLIGENCE ASSETS HOLDING (SINGAPORE) PRIVATE LIMITED, Singapore (CN)

(72) Inventors: Wu QIN, Hangzhou, Zhejiang (CN); Zhengheng WANG, Hangzhou, Zhejiang (CN); Guoyun ZHU, Hangzhou, Zhejiang (CN); Wei ZHANG, Hangzhou, Zhejiang (CN); Feifei LI, Hangzhou, Zhejiang (CN)

(21) Appl. No.: 18/861,543

(22) PCT Filed: Jun. 12, 2023
(86) PCT No.: PCT/CN2023/099763

§ 371 Date: Oct. 29, 2024

(30) Foreign Application Priority Data
Jun. 17, 2022 (CN) 202210689985.8

(51) Int. Cl. G06F 3/06

(52) U.S. Cl. CPC G06F 3/0638; G06F 3/065; G06F 3/0676

(57) ABSTRACT

Embodiments of the specification provide a data processing method and apparatus, where the data processing method includes: determining a memory allocation area corresponding to a regional address and a memory allocator associated with the memory allocation area; obtaining index data of the memory allocation area and an allocation state of the memory allocator, and writing the index data and the allocation state to a magnetic disk file; reading the index data and the allocation state from the magnetic disk file upon restarting an in-memory database containing the memory allocation area; and mapping the index data to the memory allocation area according to the regional address, and performing an update on a state of the memory allocator according to the allocation state.

### CROSS-REFERENCE TO RELATED APPLICATIONS

This application is a National Stage of International Application No. PCT/CN2023/099763, and filed on Jun. 12, 2023, which claims priority to Chinese patent application No. 202210689985.8, filed to the China National Intellectual Property Administration on Jun. 17, 2022 and entitled “DATA PROCESSING METHOD AND APPARATUS”. The disclosures of the aforementioned applications are hereby incorporated by reference in their entireties.

### TECHNICAL FIELD

Embodiments of the specification relates to the field of database technologies and, in particular, to a data processing method and apparatus.

### BACKGROUND

An in-memory database refers to a database that places data in a memory for direct manipulation, which has a faster read and write speed in comparison with that of a magnetic disk, and it can greatly improve performance of an application by storing the data in the memory in comparison with accessing the data from the disk. However, since the in-memory database is supported based on a computer memory, the problem of persistence thereof has always existed. To solve this problem, in the prior art, it will backup indexes in the memory at a set time node, so that the in-memory database is available for an application to continue running through the backup indexes after being restarted. However, when the in-memory database is restarted, it takes a certain amount of time to scan the data to achieve recovery of the indexes. And it takes a lot of time to recover the indexes when the amount of data is large, which restricts the expansion capability of the in-memory database. Therefore, an effective solution is urgently needed to solve the above problem.

### SUMMARY

In view of this, an embodiment of the specification provides a data processing method. One or more embodiments of the specification also relate to a data processing apparatus, a computing device, a computer readable storage medium, and a computer program to address the technical deficiency in the prior art.

According to a first aspect of an embodiment of the specification, a data processing method is provided, including:
determining a memory allocation area corresponding to a regional address and a memory allocator associated with the memory allocation area;
obtaining index data of the memory allocation area and an allocation state of the memory allocator, and writing the index data and the allocation state to a magnetic disk file;
reading the index data and the allocation state from the magnetic disk file upon restarting an in-memory database containing the memory allocation area;
mapping the index data to the memory allocation area according to the regional address, and performing an update on a state of the memory allocator according to the allocation state.

According to a second aspect of an embodiment of the specification, a data processing apparatus is provided, including:
a determining module, configured to determine a memory allocation area corresponding to a regional address and a memory allocator associated with the memory allocation area;
an obtaining module, configured to obtain index data of the memory allocation area and an allocation state of the memory allocator, and write the index data and the allocation state to a magnetic disk file;
a reading module, configured to read the index data and the allocation state from the magnetic disk file upon restarting an in-memory database containing the memory allocation area;
a updating module, configured to map the index data to the memory allocation area according to the regional address, and perform an update on a state of the memory allocator according to the allocation state.

According to a third aspect of an embodiment of the specification, a computing device is provided, including:
a memory and a processor;
where the memory is configured to store computer executable instructions which, when executed by the processor, implement steps of the data processing method described above.

According to a fourth aspect of an embodiment of the specification, a computer readable storage medium is provided, where computer readable storage medium stores computer executable instructions which, when executed by a processor, implement steps of the data processing method described above.

According to a fifth aspect of an embodiment of the specification, a computer program is provided, where the computer program, when executed in a computer, causes the computer to execute steps of the data processing method described above.

The data processing method provided in the specification can obtain index data of a memory allocation area and an allocation state of the memory allocator after determining a memory allocation area corresponding to a regional address and managing the memory allocator of the memory allocation area; at this time, the index data and the allocation state can be written to the magnetic disk file together, and the index and the state can be persisted through physical replication, so as to avoid the problem of inability to recover indexes due to the restart of the in-memory database. After the in-memory database containing the memory allocation area is restarted, the index data and the allocation state can be directly read from the magnetic disk file, and the index data can be mapped to the memory allocation area according to the allocation address, at the same time, the state of the memory allocator is updated according to the allocation state, thereby achieving index and state recovery in combination with the magnetic disk file, which can effectively reduce the restart time of the in-memory database and enable the in-memory database to continue to run in the state before being restarted.

### BRIEF DESCRIPTION OF DRAWINGS

FIG. 1 is a flowchart of a data processing method provided in an embodiment of the specification.

FIG. 2 is a schematic diagram of a data processing method provided in an embodiment of the specification.

FIG. 3 is a flowchart of a processing procedure of a data processing method provided in an embodiment of the specification.

FIG. 4 is a schematic structural diagram of a data processing apparatus provided in an embodiment of the specification.

FIG. 5 is a structural block diagram of a computing device provided in an embodiment of the specification.

### DESCRIPTION OF EMBODIMENTS

The following description elaborates on many specific details to facilitate a thorough understanding of the specification. However, the specification can be implemented in many different ways from those described herein, and those skilled in the art can make similar promotions without violating the content of the specification. Therefore, the specification is not limited by the specific implementation disclosed below.

Terms used in one or more embodiments of the specification are for the purpose of describing specific embodiments only and are not intended to limit one or more embodiments of the specification. The singular forms of “a/an”, “said”, and “the” used in one or more embodiments of the specification and the appended claims are also intended to include the majority, unless the context clearly indicates other meanings. It should also be understood that the term “and/or” used in one or more embodiments of the specification refers to and includes any or all possible combinations of one or more associated listed items.

It should be understood that although the terms first, second, etc., may be used to describe various pieces of information in one or more embodiments of the specification, such information should not be limited to these terms. These terms are only used to distinguish information of the same type from each other. For example, without departing from the scope of one or more embodiments of the specification, the first may also be referred to as the second, and similarly, the second may also be referred to as the first. Depending on the context, the word ‘if’ used here can be interpreted as “at the time . . . ” or “when . . . ” or “in response to determining . . . ”.

First, terminologies involved in one or more embodiments of the specification are explained.

Physical replication: refers to an operation of directly copying memory data during program running to other areas such as a memory or a magnetic disk.

Database index: refers to a data structure maintained by a database during operation and used for querying.

In-memory database: refers to a database that places data in the memory for direct manipulation; the speed of reading and writing data to and from the memory is orders of magnitude higher than that of the magnetic disk, and storing data in the memory can greatly improve the performance of an application compared to accessing it from the magnetic disk.

In the specification, a data processing method is provided, and the specification also relates to a data processing apparatus, a computing device, a computer readable storage medium, and a computer program, each of which is described in detail in the following embodiments.

In a practical application, in order to recover the indexes when being restarted, the in-memory database is mostly implemented by using redo log, checkpoint and other technologies; where the redo log is constantly generating operation records for the indexes in the process of database operation, updating the database indexes after being restarted through re-executing these records during recovery, when the record execution is complete, the index recovery is complete, but because of the need to execute the operation records in turn, the recovery speed is slower. The checkpoint is regularly scanning the indexes and saving the index memory during the operation of the database, scanning the saved memory to complete the index restoration during recovery. However, this process requires establishing the checkpoint, and the index saving speed is slow, which can interfere with the normal operation of the in-memory database. Therefore, there is an urgent need for an effective solution to address the above problem.

In view of this, the data processing method provided in the specification can obtain index data of a memory allocation area and an allocation state of the memory allocator after determining a memory allocation area corresponding to a regional address and managing the memory allocator of the memory allocation area; at this time, the index data and the allocation state can be written to the magnetic disk file together, and the index and the state can be persisted through physical replication, so as to avoid the problem of inability to recover indexes due to the restart of the in-memory database. After the in-memory database containing the memory allocation area is restarted, the index data and the allocation state can be directly read from the magnetic disk file, and the index data can be mapped to the memory allocation area according to the allocation address, at the same time, the state of the memory allocator is updated according to the allocation state, thereby achieving index and state recovery in combination with the magnetic disk file, which can effectively reduce the restart time of the in-memory database and enable the in-memory database to continue to run in the state before being restarted.

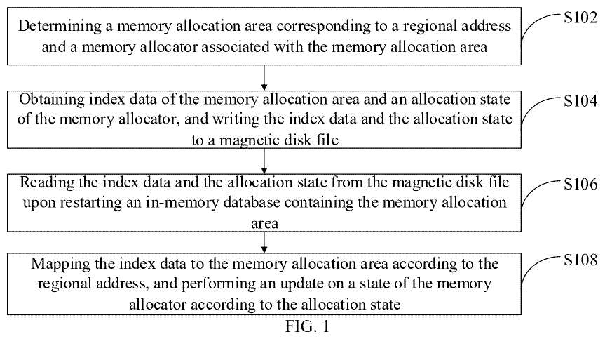

FIG. 1 illustrates a flowchart of a data processing method provided in an embodiment of the specification, which includes the following steps.

Step S102, determining a memory allocation area corresponding to a regional address and a memory allocator associated with the memory allocation area.

Specifically, the regional address specifically refers to a fixed address space used by the memory allocation area in the memory, which is used to ensure that the address of the memory allocation area will not be changed before and after the restart of the in-memory database. Correspondingly, the memory allocation area specifically refers to an allocation area in the in-memory database used to store index data, where the index data is used to operate and maintain a data structure used for queries during the operation of the in-memory database, and only by saving the index data, it can ensure that the in-memory database can continue to the operating state before and after being restarted. Correspondingly, the memory allocator specifically refers to a program that manages the memory allocation area containing memory blocks in the in-memory database, which can determine an memory allocation state of each memory block, how to allocate memory blocks in response to a query, processing of a free memory block after allocating memory blocks, and processing of releasing memory blocks.

Based on this, considering that the state of the memory block of the memory allocation area is managed by the memory allocator, when the in-memory database is restarted, if only the index data of the memory allocation area is recovered without considering the status of each memory block within the memory allocation area, it will result in significant waste of memory resources. Therefore, in order to avoid wasting memory resources, during a phase where the index data save is required for the in-memory database, the memory allocation area corresponding to the regional address can be determined, and the memory allocator associated with the memory allocation area can be determined at the same time, that is, the memory allocator of the memory allocation area is managed, an implementation that saving both the index data and the allocation state in a subsequent can be achieved, so as to improve the restart speed of the in-memory database and avoid wasting memory resources.

Furthermore, in the process of determining the memory allocation area, it is considered that the in-memory database not only includes an allocation area for storing the index data, but also includes an allocation area for storing other data, and if data is saved for all areas at this phase, it will consume more time and resources. Therefore, in order to improve resource utilization and reduce time consumption, it can be completed according to a pre-configured rule of the in-memory database; that is to say, after detecting a backup event, the determination of the memory allocation area will be completed according to the pre-configured rule. In this embodiment, the specific implementation is as follows:
determining at least two initial memory allocation areas in the in-memory database upon detecting a backup event corresponding to the in-memory database, where the at least two initial memory allocation areas include an index allocation area and a temporary allocation area; determining the regional address according to the backup event, and selecting, from the at least two initial memory allocation areas, the index allocation area as the memory allocation area according to the regional address.

Specifically, the backup event specifically refers to an event where the index data save is required for the in-memory database at the current time node, which is used to avoid that after being restarted, the in-memory database cannot being able to continue the node before being restarted and continue to run the program. Corresponding, the initial memory allocation area specifically refers to a plurality of memory allocation areas defined based on different rules in the in-memory database, including an index allocation area and a temporary allocation area. Where the index allocation area specifically refers to a memory allocation area for storing index data, and the temporary allocation area specifically refers to a memory allocation area for storing temporary data.

Based on this, when a backup event corresponding to the in-memory database is detected, it indicates that the backup of the index data is required for the in-memory database at the current time node. In this process, considering that the in-memory database contains a plurality of different initial memory allocation areas, and the data that needs to be saved only involves index data, only the initial memory allocation area for storing index data needs to be determined. Namely, the regional address can be determined according to the backup event, and then the index allocation area can be selected as the memory allocation area from the at least two initial memory allocation areas according to the regional address for subsequent index data storage and processing.

In a specific implementation, when dividing the memory allocation areas in the in-memory database, the memory allocation area that stores index data can be used as the index allocation area, while the remaining memory allocation areas are used as temporary allocation areas, which is used to distinguish the memory allocation areas in the in-memory database in a more concise form, so as to improve the efficiency of copying index data.

In summary, through distinguishing the initial memory allocation areas, on the basis of which, selecting the index allocation area corresponding to the area address as the memory allocation area for subsequent index data storage processing, the efficiency of the index data storage can be effectively improved.

S104, obtaining index data of the memory allocation area and an allocation state of the memory allocator, and writing the index data and the allocation state to a magnetic disk file.

Specifically, on the basis of the determination of the memory allocation area and the memory allocator mentioned above, furthermore, in order to achieve the persistence of the index data and the allocation state, thus after the in-memory database is restarted, the program running state before being restarted according to the index data and the allocation state, which is used to avoid resource waste. Therefore, the index data stored in the memory allocation area and the allocation state of the memory allocator can be obtained first, and then both the index data and the allocation state can be written to the magnetic disk file to achieve the purpose of persistent data storage.

The allocation state specifically refers to a state in which the memory allocator records the allocation of each memory block in the memory allocation area; correspondingly, the magnetic disk file specifically refers to a computer file that are not affected by power outages and can achieve data persistence.

In a practical application, when writing the index data to the magnetic disk file, a mmap mapping file can be used to achieve writing the index data to the magnetic disk file, or directly writing the index data to the magnetic disk file for physical copying, thereby achieving to save the index data using the magnetic disk file, so that the index data can be persistent, and avoiding loss and unusable problems.

Furthermore, in order to reduce the consumption of memory resources, and achieve that the memory allocation area can be managed and recovered in a short period of time through the memory allocator after restarting the in-memory database, it is necessary to determine the allocation state of the memory allocator and perform a persistence process on it, which can be used to reuse the allocation state of the storage after the in-memory database is restarted and reduce the startup time of the in-memory database. In this embodiment, the specific implementation is as follows:
creating a target memory allocation area associated with the memory allocation area, and switching an allocation operation of the memory allocation area to the target memory allocation area; and reading the allocation state of the memory allocator according to a switching result.

Specifically, the target memory allocation area refers to an area where the memory allocation area is not affected by other operations when storing the index data in the memory allocation area, thereby achieving that switching the allocation operation of the memory allocation area to the target memory allocation area for completion. Corresponding, the switching of the allocation operation refers to the process of switching allocation operations that occur during the storage phase of the index data to the target memory allocation area for completion.

Based on this, in order to avoid conflicts with system operation during the save process, an atomic scheme can be used to save the state of the memory allocator, that is, the saving of the allocation state and the allocation operation do not occur in the memory allocation area. That is, the memory allocator can first create a new memory allocation area, i.e., the target memory allocation area, and then the allocation operation of the memory allocation area is switched to the target memory allocation area, achieving that operations on the memory allocation area can be transferred to the target memory allocation area in the saving phase of the index data, so as to complete the corresponding allocation operation on the target memory allocation area. And the allocation state of the memory allocator is determined based on the switching result of the allocation operation.

It should be noted that when saving the index data in the memory allocation area, if the corresponding allocation operation is still performed on the old memory allocation area, it may result in inaccurate storage of the allocation state; on this basis, if the in-memory database is restarted, there may be a mismatch between the index data and the allocation state. Therefore, in order to avoid the impact of system instability caused by this problem, it is necessary to create a new memory allocation area for completing the allocation operation on the new memory allocation area.

In summary, through creating a new memory allocation area and switching the allocation operation of the old memory allocation area to the new memory allocation area, it is possible to achieve that the saving of the index data and the allocation operations do not affect each other, so that the saving of the index data can be completed without conflicts with the system operation, thereby achieving the purpose of the index data persistence.

Furthermore, when reading the allocation state according to the switching result of the allocation operation of the memory allocation area, considering that the memory allocation area contains a plurality of memory blocks, and each memory block corresponds to a different allocation state, it is necessary to integrate the allocation states of all memory blocks to determine the allocation state of the memory allocator. In this embodiment, the specific implementation is as follows:
scanning the memory allocation area according to the switching result, and determining a memory block contained in the memory allocation area; determining allocation information of the memory block according to the memory allocator; and generating the allocation state of the memory allocator through integrating the allocation information of the memory block.

Specifically, the memory block specifically refers to a smallest memory unit in the memory allocation area, where a plurality of memory blocks form the memory allocation area; correspondingly, the allocation information specifically refers to the information whether a memory block has been allocated, and the allocation state of the memory allocator can be determined through integrating the allocation information of each memory block.

Based on this, after the switching of the allocation operation of the memory allocation area is completed, the memory allocation area can be scanned, so as to determine the memory block contained in the memory allocation area; and then, the allocation information of each memory block, that is, the allocation state of each memory block is determined according to the memory allocator; finally, through integrating the allocation information of the memory blocks, the allocation state of the memory allocation area in the memory allocator can be obtained for subsequent persistence.

In summary, through scanning the allocation information of each memory block contained in the memory allocation area, the allocation state of the memory allocator can be accurately determined; on the basis of which persistence is performed, the index data written in the magnetic disk file can match with the allocation state, enabling quick startup of the in-memory database during the recovery phase.

In addition, considering that during the process of saving index data and allocation states, the memory allocation area may receive a release instruction, if the release operation is directly executed in the memory allocation area, it may cause a problem where the saved allocation state does not correspond to the current allocation state; on the basis of which the in-memory database is restarted, the release operation cannot be executed. Therefore, in order to avoid the above problems, the release process can be completed for the state of the memory block corresponding to the release operation. In this embodiment, the specific implementation is as follows:
determining a target memory block upon receiving a memory block release instruction submitted for the memory allocation area; checking whether a target allocation state of the target memory block is saved to the magnetic disk file; if not, performing delayed processing on the memory block release instruction until the target allocation state is written to the magnetic disk file, and releasing a memory block mapped to the target memory block in the target memory allocation area according to the memory block release instruction; and if so, releasing the memory block mapped to the target memory block in the target memory allocation area according to the memory block release instruction.

Specifically, the memory block release instruction specifically refers to an operation of releasing the target memory block contained in the memory allocation area, which is used to delete the data stored in the target memory block; correspondingly, the target memory block specifically refers to a memory block on which the release operation is currently being performed in the memory allocation area. Correspondingly, the target allocation state specifically refers to an allocation state of the target memory block.

Based on this, when persisting the allocation state of the memory allocator, if a memory block release instruction submitted for the memory allocation area is received, the target memory block that needs to be released indicated by the memory block release instruction can be determined. At this time, it is possible to check whether the target allocation state of the target memory block has been saved to the magnetic disk file, that is, to check whether the target allocation state is persistent; if not, it means that the target allocation state of the target memory block has not been written to the magnetic disk file yet, and if the target memory block continues to be released, it will affect system operation and cause system conflicts, which will affect the storage of the index data and the allocation state. Therefore, in order to complete memory release without affecting data storage, the memory block release instruction can be delayed, that is, the memory release operation can be delayed until the target allocation state is written to the magnetic disk file, and then according to the delayed memory block release instruction, the memory block mapped to the target memory block can be released in the target memory allocation area.

If so, it means that the target allocation state of the target memory block has been written to the magnetic disk file, and the release processing will not affect writing the allocation state to the magnetic disk file. Therefore, the memory block release instruction can be directly executed to release the memory block mapped to the target memory block in the target memory allocation area.

It should be noted that the target memory allocation area is a newly created memory allocation area for the memory allocation area. Therefore, when executing the memory block release instruction, the memory block mapped to the target memory block needs to be released in the target memory allocation area to achieve the purpose of releasing memory resources. In a practical application, when performing delayed processing on the memory block release instruction, tcache can be used to cache a release operation, which is used to achieve delayed processing.

In addition, after the allocation state is saved, in order to avoid resource waste, and considering that the old memory allocation area may still contain a memory block that are not managed by the target memory allocation area, thus, the memory allocation area and the target memory allocation area can be merged. That is, ownership of the old memory allocation area is transferred to the new memory allocation area, which enables the memory allocator to manage all memory blocks.

In summary, when the release operation occurs during the storage period, it can be processed according to different situations of the release operation, achieving the processing of the release operation without affecting the saving of the allocation state, thereby improving the concurrent processing capability of the system.

Furthermore, after obtaining the index data and the allocation state, considering that the index data may contain running index data, which only exists during the program running phase, if it is saved, the storage resources will be wasted. Therefore, after saving the index data, it can be compressed to reduce the storage space occupation. In this embodiment, the specific implementation is as follows:
determining running index data contained in the index data; and deleting the running index data from the index data, and writing the index data in which the running index data has been deleted to the magnetic disk file.

Specifically, the running index data refers to index data that exists in the in-memory database during the program running process, after the program is stopped or closed, this part of the index data will also be released. That is, the running index data only exists during the program running process, and the program is in a running state during the index data saving phase; at this time, the index data would contain running index data, if all index data is saved at this time, it will consume more storage space. In order to improve space utilization, it is possible to first determine the running index data in the index data, then delete the running index data and write the index data of the running index data to the magnetic disk file to achieve the purpose of saving space resources.

In a practical application, when saving index data that does not contain running index data, it is also possible to reduce the storage space occupied by running index data through compressing the saved result after all index data is written to the magnetic disk file. That is, after the index data is written to the magnetic disk file, the running index data is determined from the index data written to the magnetic disk file, and then the running index data is deleted from the magnetic disk file to achieve the purpose of saving storage space resources. Where the running index data includes but is not limited to a linked list structure, a linked list pointer, etc.

In specific implementation, the compression manner for index data can be selected according to the actual application scenario, and this embodiment is not limited in any way.

In summary, through using the method of deleting running index data to reduce the amount of the index data written to the magnetic disk file, the efficiency of the index data writing can be effectively improved, and the waste of storage resources can be avoided, and it is also possible to quickly restart the in-memory database based on a small amount of the index data in the subsequent recovery phase.

Furthermore, when writing the allocation state of the memory allocator to the magnetic disk file, it is considered that the allocation state is a state of the memory block contained in the memory allocation area, and different memory blocks may have different allocation states at the current time, namely an allocated or an unallocated state. And if the state corresponding to the unallocated memory block is also saved, it will also be considered unused during the recovery phase and will not affect the recovery operation of the program; thus, if its state is saved, it will slow down the startup speed of the in-memory database. Therefore, when allocation state storage, the unallocated memory block can be released, and then the allocation state can be updated to reduce the space occupancy of the allocation state; finally, it can be written to the magnetic disk file. In this embodiment, the specific implementation is as follows:
determining a to-be-released memory block that has not been allocated in the memory allocation area according to the allocation state, and performing release processing on the to-be-released memory block; and performing an update on the allocation state according to a release processing result, and writing an updated allocation state to the magnetic disk file.

Specifically, the to-be-released memory block refers to an unused memory block in the memory allocation area, that is, the unallocated memory block. Based on this, when storing the allocation state, the allocation state can be traversed first to determine the allocation state of each memory block in the memory allocation area; and then, the unallocated memory block can be selected as the to-be-released memory block; by performing release processing on the to-be-released memory block, it achieves returning the to-be-released memory block to the in-memory database; at this point, the allocation state can be updated based on the release result, which is used to remove the allocation state of the released to-be-released memory block; finally, the updated allocation state can be written to the magnetic disk file, which is used to achieve the compress of the space occupancy rate of the allocation state.

For example, the memory allocation area is divided into n blocks for use, and a bitmap data structure is used to store the allocation state of each block. If all n memory blocks are used and continuing to use the bitmap, more memory space will be occupied. Therefore, 1 bit can be used to represent that all n memory blocks are allocated for use. At this time, the bitmap can be deleted without writing it to the magnetic disk file, so as to save space resources.

In summary, through adopting the manner of releasing the to-be-released memory block, the file size of the allocation state can be reduced, so that the allocation state written to the magnetic disk file will not contain redundant information, thereby reducing the amount of data of the allocation state that needs to be recovered and improving the startup speed of the in-memory database.

S106, reading the index data and the allocation state from the magnetic disk file upon restarting an in-memory database containing the memory allocation area.

Specifically, after writing the index data and the allocation state to the magnetic disk file as described above, the program can continue to be provided with a running environment through the in-memory database. If the in-memory database is restarted due to external factors such as system crashes or power outages after the index data and the allocation state are written to the magnetic disk file and before the next rewrite of new index data and allocation state, the index data and the allocation state in the magnetic disk file can be used to restart the in-memory database, so as to recover the in-memory database to a state before being restarted and continue to provide a running environment for the program. Therefore, after restarting the in-memory database containing the memory allocation area, the index data and the allocation state can be read from the magnetic disk file, and then the index data can be restored to memory, and the memory allocator can be updated according to the allocation state, so as to achieve the purpose of restarting the in-memory database and restoring the program running environment.

Furthermore, considering that during the restart phase of the in-memory database, it provides a memory for the program to continue running with the highest priority, thus the recovery of the index data and the allocation state can be completed according to the restart configuration information of the in-memory database. In this embodiment, the specific implementation is as follows:
obtaining restart configuration information preset for the in-memory database, and performing restart processing on the in-memory database according to the restart configuration information; detecting whether snapshot information of the memory allocator is available according to a restart processing result of the in-memory database; if so, performing a step of reading the index data and the allocation state from the magnetic disk file; and if not, restarting the program and rebuild the index.

Specifically, the restart configuration information specifically refers to information that records a startup priority of each function when the in-memory database is restarted, which is used to control the restart phase of the in-memory database and the restart sequence of each function; correspondingly, the snapshot information specifically refers to information stored in the allocation state of the memory allocator, and it can be determined whether the index data and the allocation state can be recovered through determining whether the snapshot information is available.

Based on this, during the restart phase of the in-memory database, the restart configuration information of the in-memory database can be obtained first, and the in-memory database can be restarted according to the restart configuration information, thereby achieving restarting partial functions in the in-memory database in an chronological order, and achieving calling too many computing resources through a linear restart method at the same time. After being restarted, in order to recover the state of the in-memory database to the state before being restarted, it is necessary to check the snapshot information of the memory allocator. If the snapshot information is available, it indicates that the index data and the allocation state written in the magnetic disk file are not damaged; at this point, S106 can be executed to read the index data and the allocation state from the magnetic disk file for future use. If the snapshot information is unavailable, it means that the index data and the allocation state written in the magnetic disk file are damaged, at this point, it is necessary to restart the startup program and rebuild the index.

In summary, the in-memory database is restarted through adopting the restart configuration information, the occurrence of problems of high concurrent memory usage is reduced through restarting partial functions by adopting a linear restarting method, thereby improving the restart speed of the in-memory database, achieving the recovery of the program operation in a shorter period of time, and avoiding affecting the downstream services due to longer program interruption.

S108, mapping the index data to the memory allocation area according to the regional address, and performing an update on a state of the memory allocator according to the allocation state.

Specifically, after reading the index data and the allocation state from the magnetic disk file, in order to recover the state of the in-memory database to the state before being restarted, the index data can be mapped to the memory allocation area according to the regional address, and a state of the memory allocator can be updated according to the allocation state, which is used to recover the state of the restarted in-memory database to the state before being restarted, so as to continue running the program.

Furthermore, when reading index data from the magnetic disk file and mapping it to the memory allocation area, it is actually that the area address can be determined according to the information recorded in the magnetic disk file after the in-memory database is restarted, thereby determining the memory allocation area in the in-memory database, and then, the index data can be read from the magnetic disk file and mapped back to the memory to complete the reconstruction of the index.

Furthermore, after the index data recovery is completed, it is necessary to recover the allocation state to avoid the problem of memory resource waste. Therefore, it is necessary to first re-register the memory allocation area to the memory allocator and then perform state recovery. In this embodiment, the specific implementation is as follows:
registering the memory allocation area in the memory allocator, and scanning the allocation state according to a registration result; and performing an update on the allocation information of the memory block contained in the memory allocation area according to a scanning result as an update of the state of the memory allocator.

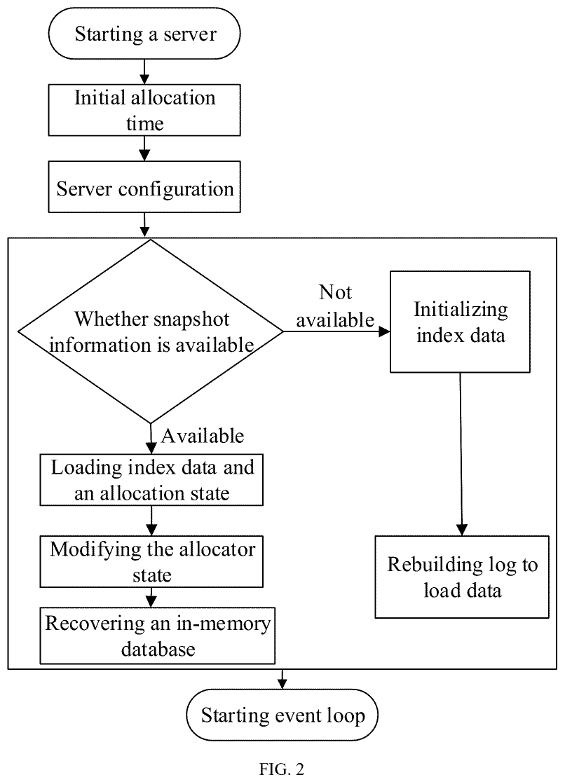

Referring to the schematic diagram shown in FIG. 2, after the started server loads the server configuration from the initial allocation time, partial functions can be selectively started to improve the startup speed of the in-memory database. On this basis, during the process of pulling up the in-memory database, the first step is to attempt to read the state of the memory allocator, and after success, map the index data to the memory allocation area; at this point, the operating state of the system will be the same as that before generating the snapshot. However, it will result in significant waste of memory resources due to the loss of the corresponding memory allocator state, and the in-memory database cannot continue to operate normally. Therefore, it is also necessary to restore the state of the memory allocator.

That is, it is necessary to first register the memory allocation area in the memory allocator, and then scan the allocation state according to the registration result; so as to update the allocation information of the memory block contained in the memory allocation area according to the scan result as a state update for the memory allocator, to achieve that updates the individual allocation states of the memory block into the memory allocator. That is, the memory allocation area is firstly re-registered with the memory allocator, and then the saved allocation state is scanned to modify the allocator state of the corresponding memory block to “allocated”, thereby achieving that updating the state of each memory block in the memory allocation area to the memory allocator.

As shown in FIG. 2, after being restarted, the in-memory database will firstly check whether the snapshot information of the memory allocator is available, if it is available, it will load the index data and the allocation state, and then modify the allocator state of the corresponding area to achieve the recovery processing of the in-memory database. If the snapshot information is unavailable, it initializes index data and rebuilding log to load data. And at any recovery node, the in-memory database will be restarted according to the above logic, which is used to maintain the continuity of the in-memory database before and after being restarted.

In summary, through the manner of re-registering the memory allocation area and restoring the allocation state, it is possible to avoid the loss of memory allocator state, greatly improve the utilization of memory resources, and avoid resource waste in the case of state loss.

In addition, in order to avoid the problem of holes, the memory allocation area can be scanned again after recovering the allocation state, which is used to return unallocated memory blocks. In this embodiment, the specific implementation is as follows:
scanning the memory allocation area by the memory allocator whose state has been updated, and determining a free memory block that has not been allocated in the memory allocation area; and performing release processing on the free memory block.

Specifically, the free memory block specifically refers to an unallocated memory block after the memory allocation area is re-registered with the memory allocator. Based on this, after the state update of the memory allocator is completed, the memory allocation area can be rescanned to determine the unallocated free memory block in the memory allocation area; afterwards, the free memory block will be released, thereby achieving returning the unallocated area to the in-memory database, and improving memory utilization.

In summary, after restoring the in-memory database, the memory allocation area is scanned again, it can achieve reclaiming the free memory block, and achieve the purpose of improving memory space utilization.

The data processing method provided in the specification can obtain index data of a memory allocation area and an allocation state of the memory allocator after determining a memory allocation area corresponding to a regional address and managing the memory allocator of the memory allocation area; at this time, the index data and the allocation state can be written to the magnetic disk file together, and the index and the state can be persisted through physical replication, so as to avoid the problem of inability to recover indexes due to the restart of the in-memory database. After the in-memory database containing the memory allocation area is restarted, the index data and the allocation state can be directly read from the magnetic disk file, and the index data can be mapped to the memory allocation area according to the allocation address, at the same time, the state of the memory allocator is updated according to the allocation state, thereby achieving index and state recovery in combination with the magnetic disk file, which can effectively reduce the restart time of the in-memory database and enable the in-memory database to continue to run in the state before being restarted.

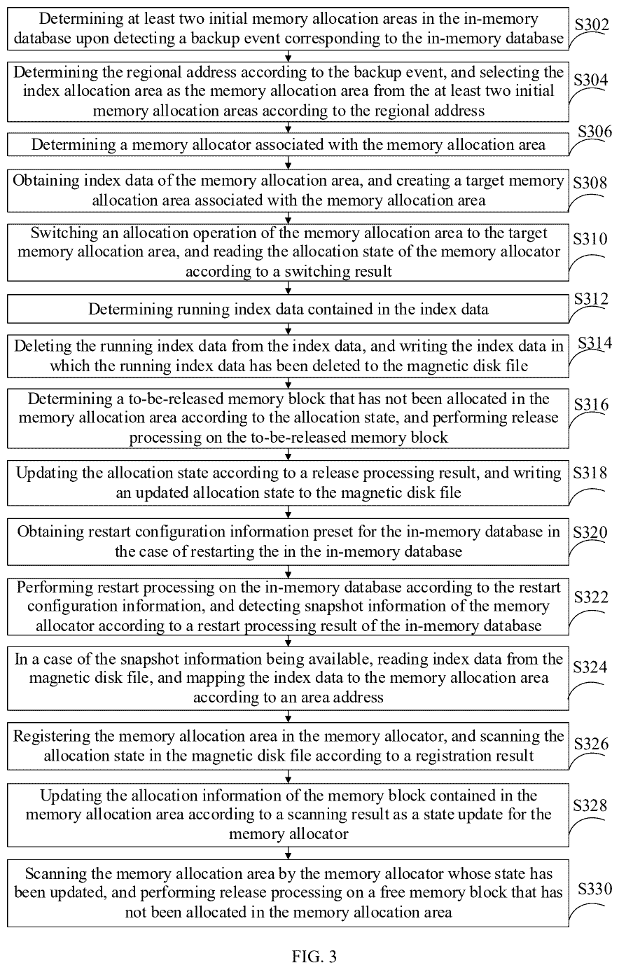

Taking the application of the data processing method provided in the specification in the scenario of in-memory database recovery as an example, combined with FIG. 3, the data processing method is further explained. FIG. 3 illustrates a flowchart of a processing procedure of a data processing method provided in an embodiment of the specification, which includes the following steps.

S302, determining at least two initial memory allocation areas in the in-memory database upon detecting a backup event corresponding to the in-memory database.

S304, determining the regional address according to the backup event, and selecting the index allocation area as the memory allocation area from the at least two initial memory allocation areas according to the regional address.

S306, determining a memory allocator associated with the memory allocation area.

S308, obtaining index data of the memory allocation area, and creating a target memory allocation area associated with the memory allocation area.

S310, switching an allocation operation of the memory allocation area to the target memory allocation area, and reading the allocation state of the memory allocator according to a switching result.

S312, determining running index data contained in the index data.

S314, deleting the running index data from the index data, and writing the index data in which the running index data has been deleted to the magnetic disk file.

S316, determining a to-be-released memory block that has not been allocated in the memory allocation area according to the allocation state, and performing release processing on the to-be-released memory block.

S318, updating the allocation state according to a release processing result, and writing an updated allocation state to the magnetic disk file.

During this process, it determines a target memory block upon receiving a memory block release instruction submitted for the memory allocation area; it checks whether a target allocation state of the target memory block is saved to the magnetic disk file; if not, it performs delayed processing on the memory block release instruction until the target allocation state is written to the magnetic disk file, and releases a memory block mapped to the target memory block in the target memory allocation area according to the memory block release instruction; and if so, it releases the memory block mapped to the target memory block in the target memory allocation area according to the memory block release instruction.

S320, obtaining restart configuration information preset for the in-memory database in the case of restarting the in the in-memory database.

S322, performing restart processing on the in-memory database according to the restart configuration information, and detecting snapshot information of the memory allocator according to a restart processing result of the in-memory database.

S324, in a case of the snapshot information being available, reading index data from the magnetic disk file, and mapping the index data to the memory allocation area according to an area address.

S326, registering the memory allocation area in the memory allocator, and scanning the allocation state in the magnetic disk file according to a registration result.

S328, updating the allocation information of the memory block contained in the memory allocation area according to a scanning result as a state update for the memory allocator.

S330, scanning the memory allocation area by the memory allocator whose state has been updated, and performing release processing on a free memory block that has not been allocated in the memory allocation area.

In conclusion, after determining a memory allocation area corresponding to a regional address and managing the memory allocator of the memory allocation area, index data of a memory allocation area and an allocation state of the memory allocator can be obtained; at this time, the index data and the allocation state can be written to the magnetic disk file together, and the index and the state can be persisted through physical replication, so as to avoid the problem of inability to recover indexes due to the restart of the in-memory database. After the in-memory database containing the memory allocation area is restarted, the index data and the allocation state can be directly read from the magnetic disk file, and the index data can be mapped to the memory allocation area according to the allocation address. At the same time, the state of the memory allocator is updated according to the allocation state, thereby achieving index and state recovery in combination with the magnetic disk file, which can effectively reduce the restart time of the in-memory database and enable the in-memory database to continue to run in the state before being restarted.

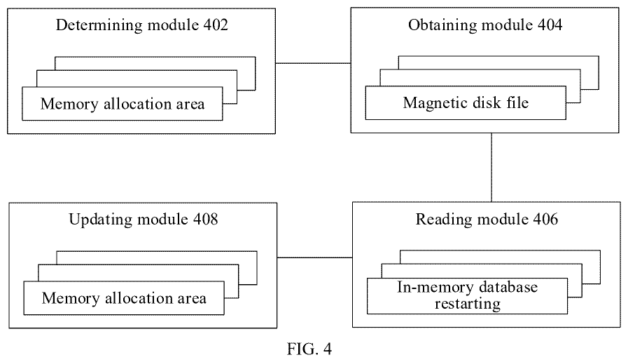

Corresponding to the above method embodiments, the specification also provides an embodiment of a data processing apparatus. FIG. 4 illustrates a schematic structural diagram of a data processing apparatus provided in an embodiment of the specification. As shown in FIG. 4, the apparatus includes:
a determining module 402, configured to determine a memory allocation area corresponding to a regional address and a memory allocator associated with the memory allocation area;
an obtaining module 404, configured to obtain index data of the memory allocation area and an allocation state of the memory allocator, and write the index data and the allocation state to a magnetic disk file;
a reading module 406, configured to read the index data and the allocation state from the magnetic disk file upon restarting an in-memory database containing the memory allocation area; and
an updating module 408, configured to map the index data to the memory allocation area according to the regional address, and perform an update on a state of the memory allocator according to the allocation state.

In an embodiment, the determination module 402 is further configured to:
determine at least two initial memory allocation areas in the in-memory database upon detecting a backup event corresponding to the in-memory database, where the at least two initial memory allocation areas include an index allocation area and a temporary allocation area; and determine the regional address according to the backup event, and select, from the at least two initial memory allocation areas, the index allocation area as the memory allocation area among the at least two initial memory allocation areas according to the regional address.

In an embodiment, the obtaining module 404 is further configured to:
determine a to-be-released memory block that has not been allocated in the memory allocation area according to the allocation state, and perform release processing on the to-be-released memory block; and perform an update on the allocation state according to a release processing result, and write an updated allocation state to the magnetic disk file.

In an embodiment, the obtaining module 404 is further configured to:
determine running index data contained in the index data; and delete the running index data from the index data, and write the index data in which the running index data has been deleted to the magnetic disk file.

In an embodiment, the obtaining module 404 is further configured to:
create a target memory allocation area associated with the memory allocation area, and switch an allocation operation of the memory allocation area to the target memory allocation area; and read the allocation state of the memory allocator according to a switching result.

In an embodiment, the obtaining module 404 is further configured to:
scan the memory allocation area according to the switching result, and determine a memory block contained in the memory allocation area; determine allocation information of the memory block according to the memory allocator; and generate the allocation state of the memory allocator through integrating the allocation information of the memory block.

In an embodiment, the apparatus further includes:
a release processing module, configured to determine a target memory block upon receiving a memory block release instruction submitted for the memory allocation area; check whether a target allocation state of the target memory block is saved to the magnetic disk file; if not, perform delayed processing on the memory block release instruction until the target allocation state is written to the magnetic disk file, and release a memory block mapped to the target memory block in the target memory allocation area according to the memory block release instruction; if so, release the memory block mapped to the target memory block in the target memory allocation area according to the memory block release instruction.

In an embodiment, the reading module 406 is further configured to:
obtain restart configuration information preset for the in-memory database, and perform restart processing on the in-memory database according to the restart configuration information; detect whether snapshot information of the memory allocator is available according to a restart processing result of the in-memory database; if so, perform a step of reading the index data and the allocation state from the magnetic disk file.

In an embodiment, the updating module 408 is further configured to:
register the memory allocation area in the memory allocator, and scan the allocation state according to a registration result; and perform an update on the allocation information of the memory block contained in the memory allocation area according to a scanning result as an update of the state of the memory allocator.

In an embodiment, the apparatus further includes:
a release module, configured to scan the memory allocation area by the memory allocator whose state has been updated, and determine a free memory block that has not been allocated in the memory allocation area; and perform release processing on the free memory block.

The data processing apparatus provided in the specification can obtain index data of a memory allocation area and an allocation state of the memory allocator after determining a memory allocation area corresponding to a regional address and managing the memory allocator of the memory allocation area; at this time, the index data and the allocation state can be written to the magnetic disk file together, and the index and the state can be persisted through physical replication, so as to avoid the problem of inability to recover indexes due to the restart of the in-memory database. After the in-memory database containing the memory allocation area is restarted, the index data and the allocation state can be directly read from the magnetic disk file, and the index data can be mapped to the memory allocation area according to the allocation address. At the same time, the state of the memory allocator is updated according to the allocation state, thereby achieving index and state recovery in combination with the magnetic disk file, which can effectively reduce the restart time of the in-memory database and enable the in-memory database to continue to run in the state before being restarted.

The above is a schematic scheme of the data processing apparatus in this embodiment. It should be noted that the technical solution of the data processing apparatus belongs to the same concept as the technical solution of the data processing method mentioned above. For details not described in detail in the technical solution of the data processing apparatus, please refer to the description of the technical solution of the data processing method mentioned above.

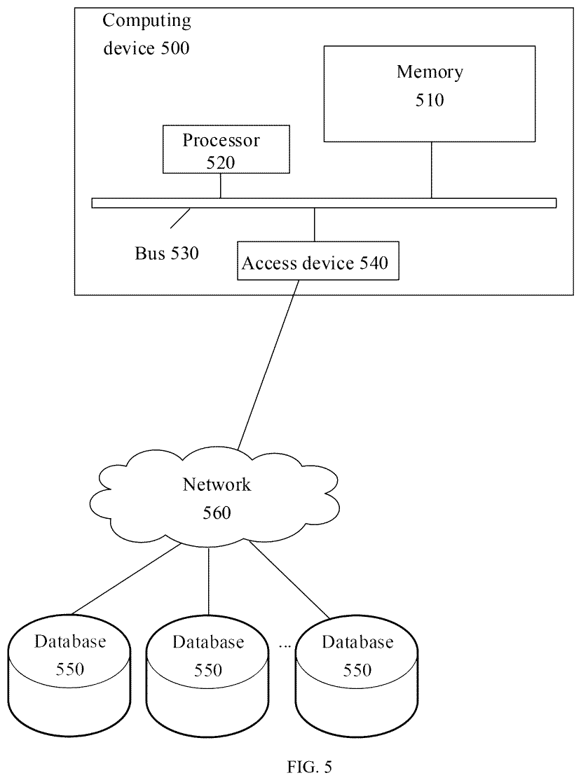

FIG. 5 illustrates a structural block diagram of a computing device 500 provided according to an embodiment of the specification. Components of the computing device 500 include but are not limited to a memory 510 and a processor 520. The processor 520 is connected to the memory 510 through a bus 530, and a database 550 is used to store data.

The computing device 500 also includes an access device 540, and the access device 540 enables the computing device 500 to perform communication via one or more networks 560. Examples of these networks include a public switched telephone network (PSTN), a local area network (LAN), a wide area network (WAN), a personal area network (PAN), or a combination of communication networks such as Internet. The access device 540 may include one or more of any type of wired or wireless network interfaces (e.g., network interface card (NIC)), such as an IEEE 802.11 wireless local area network (WLAN) wireless interface, a global microwave internet access (Wi-MAX) interface, an Ethernet interface, a universal serial bus (USB) interface, a cellular network interface, a Bluetooth interface, a near field communication (NFC) interface, and so on.

In an embodiment of the specification, the above components of the computing device 500 and other components not shown in FIG. 5 may also be connected to each other, such as through the bus. It should be understood that the structure diagram of the computing device shown in FIG. 5 is for illustrative purposes only and not to limit the scope of the specification. Those skilled in the art can add or replace other components as needed.

The computing device 500 can be any type of stationary or mobile computing device, which includes a mobile computer or a mobile computing device (such as a tablet computer, a personal digital assistant, a laptop computer, a netbook computer, netbook, etc.), a mobile phone (such as a smartphone), a wearable computing device (such as a smart watch, a smart glass, etc.), or other types of mobile devices, such as a desktop computer or stationary computing devices of PC. The computing device 500 can also be a mobile or stationary server.

The processor 520 is used to execute the following computer executable instructions which, when executed by the processor, implement steps of the data processing method described above.

The above is a schematic scheme of the computing device in this embodiment. It should be noted that the technical solution of the computing device belongs to the same concept as the technical solution of the data processing method mentioned above. For details not described in detail in the technical solution of the computing device, please refer to the description of the technical solution of the data processing method mentioned above.

An embodiment of the specification also provides a computer readable storage medium storing computer executable instructions which, when executed by a processor, implement steps of the data processing method described above.

The above is a schematic scheme of the computer readable storage medium in this embodiment. It should be noted that the technical solution of the storage medium belongs to the same concept as the technical solution of the data processing method mentioned above. For details not described in detail in the technical solution of the storage medium, please refer to the description of the technical solution of the data processing method mentioned above.

An embodiment of the specification also provides a computer program which, when executed by a computer, causes the computer to execute steps of the data processing method described above.

The above is a schematic scheme of the computer program in this embodiment. It should be noted that the technical solution of the computer program belongs to the same concept as the technical solution of the data processing method mentioned above. For details not described in detail in the technical solution of the computer program, please refer to the description of the technical solution of the data processing method mentioned above.

The specific embodiments of the specification have been described above. Other embodiments are within the scope of the appended claims. In some cases, actions or steps described in the claims may be performed in a different order than those in the embodiments and still achieve the desired results. In addition, the process depicted in the drawings does not necessarily require a specific or continuous order to achieve the desired results. In some implementations, multitasking and parallel processing are also possible or may be advantageous.

The computer instructions include computer program codes, which can be in the form of source codes, object codes, an executable file, or some intermediate forms. The computer readable medium may include any entity or apparatus capable of carrying the computer program codes, a recording medium, a USB flash disk, a mobile hard disk drive, a diskette, a compact disc, a computer memory, a read-only memory (ROM), a random access memory (RAM), distribution media of an electric carrier signal, a telecommunication signal, and software. It should be noted that the content contained in the computer readable medium may be appropriately added or removed according to requirements of legislation and patent practice within the jurisdiction. For example, in some jurisdictions, according to legislation and patent practice, the computer readable medium does not include a carrier signal and a telecommunication signal.

It should be noted that for the sake of simplicity, the aforementioned method embodiments are described as a series of action combinations. However, those skilled in the art should be aware that the embodiments in the specification are not limited by the order of actions described, as certain steps may be performed in other orders or simultaneously according to the embodiments in the specification. Secondly, those skilled in the art should also be aware that the embodiments described in the specification are all preferred embodiments, and the actions and the modules involved may not necessary for the embodiments in the specification.

In the above embodiments, the description of each embodiment has its own emphasis. For the parts that are not detailed in an embodiment, please refer to relevant descriptions of other embodiments.

The preferred embodiments of the description disclosed above are only intended to assist in illustrating the specification. The embodiments do not provide a detailed description of all the details, nor do they limit the present disclosure to only the specific implementations described. Obviously, many modifications and changes can be made based on the content of the embodiments in the specification. The specification selects and specifically describes these embodiments to better explain principles and practical applications of the embodiments in the specification, so that those skilled in the art can understand and utilize the specification well. The specification is limited only by the claims and their full scope and equivalents.

1. A data processing method, comprising:
determining a memory allocation area corresponding to a regional address and a memory allocator associated with the memory allocation area;
obtaining index data of the memory allocation area and an allocation state of the memory allocator, and writing the index data and the allocation state to a magnetic disk file;
reading the index data and the allocation state from the magnetic disk file upon restarting an in-memory database containing the memory allocation area;
mapping the index data to the memory allocation area according to the regional address, and performing an update on a state of the memory allocator according to the allocation state.

2. The method according to claim 1, wherein the determining the memory allocation area corresponding to the regional address comprises:
determining at least two initial memory allocation areas in the in-memory database upon detecting a backup event corresponding to the in-memory database, wherein the at least two initial memory allocation areas comprise an index allocation area and a temporary allocation area;
determining the regional address according to the backup event, and selecting, from the at least two initial memory allocation areas, the index allocation area as the memory allocation area according to the regional address.

3. The method according to claim 1, wherein the writing the allocation state to the magnetic disk file comprises:
determining a to-be-released memory block that has not been allocated in the memory allocation area according to the allocation state, and performing release processing on the to-be-released memory block;
performing an update on the allocation state according to a release processing result, and writing an updated allocation state to the magnetic disk file.

4. The method according to claim 1, wherein the writing the index data to the magnetic disk file comprises:
determining running index data contained in the index data;
deleting the running index data from the index data, and writing the index data in which the running index data has been deleted to the magnetic disk file.

5. The method according to claim 1, wherein the obtaining the allocation state of the memory allocator comprises:
creating a target memory allocation area associated with the memory allocation area, and switching an allocation operation of the memory allocation area to the target memory allocation area;
reading the allocation state of the memory allocator according to a switching result.

6. The method according to claim 5, wherein the reading the allocation state of the memory allocator according to the switching result comprises:
scanning the memory allocation area according to the switching result, and determining a memory block contained in the memory allocation area;
determining allocation information of the memory block according to the memory allocator;
generating the allocation state of the memory allocator through integrating the allocation information of the memory block.

7. The method according to claim 5, further comprising:
determining a target memory block upon receiving a memory block release instruction submitted for the memory allocation area;
checking whether a target allocation state of the target memory block is saved to the magnetic disk file;
if the target allocation state of the target memory block is not saved to the magnetic disk file, performing delayed processing on the memory block release instruction until the target allocation state is written to the magnetic disk file, and releasing a memory block mapped to the target memory block in the target memory allocation area according to the memory block release instruction;
if the target allocation state of the target memory block is saved to the magnetic disk file, releasing the memory block mapped to the target memory block in the target memory allocation area according to the memory block release instruction.

8. The method according to claim 1, wherein the reading the index data and the allocation state from the magnetic disk file upon restarting the in-memory database containing the memory allocation area comprises:
obtaining restart configuration information preset for the in-memory database, and performing restart processing on the in-memory database according to the restart configuration information;
detecting whether snapshot information of the memory allocator is available according to a restart processing result of the in-memory database;
based on that the snapshot information of the memory allocator is available, reading the index data and the allocation state from the magnetic disk file.

9. The method according to claim 1, wherein the performing the update on the state of the memory allocator according to the allocation state comprises:
registering the memory allocation area in the memory allocator, and scanning the allocation state according to a registration result;
performing an update on the allocation information of the memory block contained in the memory allocation area according to a scanning result as an update of the state of the memory allocator.

10. The method according to claim 1, after performing the updating on the state of the memory allocator according to the allocation state, further comprising:
scanning the memory allocation area by the memory allocator whose state has been updated, and determining a free memory block that has not been allocated in the memory allocation area;
performing release processing on the free memory block.

11. (canceled)

12. A data processing apparatus, comprising:
a memory and a processor;
wherein the memory is configured to store computer executable instructions, and the processor is configured to execute the computer executable instructions which, when executed by the processor, cause to the processor to:
determine a memory allocation area corresponding to a regional address and a memory allocator associated with the memory allocation area;
obtain index data of the memory allocation area and an allocation state of the memory allocator, and write the index data and the allocation state to a magnetic disk file;
read the index data and the allocation state from the magnetic disk file upon restarting an in-memory database containing the memory allocation area;
map the index data to the memory allocation area according to the regional address, and perform an update on a state of the memory allocator according to the allocation state.

13. A non-transitory computer readable storage medium, storing computer executable instructions which, when executed by the processor, implement the following:
determining a memory allocation area corresponding to a regional address and a memory allocator associated with the memory allocation area;
obtaining index data of the memory allocation area and an allocation state of the memory allocator, and writing the index data and the allocation state to a magnetic disk file;
reading the index data and the allocation state from the magnetic disk file upon restarting an in-memory database containing the memory allocation area;
mapping the index data to the memory allocation area according to the regional address, and performing an update on a state of the memory allocator according to the allocation state.

14. The apparatus according to claim 12, wherein the processor is further caused to:
determine at least two initial memory allocation areas in the in-memory database upon detecting a backup event corresponding to the in-memory database, wherein the at least two initial memory allocation areas comprise an index allocation area and a temporary allocation area;
determine the regional address according to the backup event, and select, from the at least two initial memory allocation areas, the index allocation area as the memory allocation area according to the regional address.

15. The apparatus according to claim 12, wherein the processor is further caused to:
determine a to-be-released memory block that has not been allocated in the memory allocation area according to the allocation state, and perform release processing on the to-be-released memory block;
perform an update on the allocation state according to a release processing result, and write an updated allocation state to the magnetic disk file.

16. The apparatus according to claim 12, wherein the processor is further caused to:
determine running index data contained in the index data;
delete the running index data from the index data, and write the index data in which the running index data has been deleted to the magnetic disk file.

17. The apparatus according to claim 12, wherein the processor is further caused to:
create a target memory allocation area associated with the memory allocation area, and switch an allocation operation of the memory allocation area to the target memory allocation area;
read the allocation state of the memory allocator according to a switching result.

18. The apparatus according to claim 17, wherein the processor is further caused to:
scan the memory allocation area according to the switching result, and determine a memory block contained in the memory allocation area;
determine allocation information of the memory block according to the memory allocator;
generate the allocation state of the memory allocator through integrating the allocation information of the memory block.

19. The apparatus according to claim 17, wherein the processor is further caused to:
determine a target memory block upon receiving a memory block release instruction submitted for the memory allocation area;
check whether a target allocation state of the target memory block is saved to the magnetic disk file;
if the target allocation state of the target memory block is not saved to the magnetic disk file, perform delayed processing on the memory block release instruction until the target allocation state is written to the magnetic disk file, and release a memory block mapped to the target memory block in the target memory allocation area according to the memory block release instruction;
if the target allocation state of the target memory block is saved to the magnetic disk file, release the memory block mapped to the target memory block in the target memory allocation area according to the memory block release instruction.

20. The apparatus according to claim 12, wherein the processor is further caused to:
obtain restart configuration information preset for the in-memory database, and perform restart processing on the in-memory database according to the restart configuration information;
detect whether snapshot information of the memory allocator is available according to a restart processing result of the in-memory database;
based on that the snapshot information of the memory allocator is available, read the index data and the allocation state from the magnetic disk file.

21. The apparatus according to claim 12, wherein the processor is further caused to:
register the memory allocation area in the memory allocator, and scan the allocation state according to a registration result;
perform an update on the allocation information of the memory block contained in the memory allocation area according to a scanning result as an update of the state of the memory allocator.
